(19) United States
(12) Patent Application Publication
(10) Pub. No.: US 2015/0119769 A1
(43) Pub. Date: Apr. 30, 2015

(54) WEARABLE RHYTHMIC DEVICE

(71) Applicants: Alexander Z. Golbin, Northbrook, IL (US); Leonid Danushevsky, Rolling Meadows, IL (US)

(72) Inventors: Alexander Z. Golbin, Northbrook, IL (US); Leonid Danushevsky, Rolling Meadows, IL (US)

(21) Appl. No.: 14/066,934

(22) Filed: Oct. 30, 2013

(51) Int. Cl. A61H 23/02

(52) U.S. Cl. CPC A61H 23/02
USPC 601/48

(57) ABSTRACT

A wearable rhythmic device and method for imparting vibrational rhythms to the wearer is described. The device generally includes wearable band having a housing connected thereto, and a rhythm and vibration mechanism contained within the housing. Use of the device may induce different states of mind and physiological states in a wearer, varying from active and energetic alertness to relaxation.

### TECHNICAL FIELD OF THE INVENTION

The present invention relates to wearable therapeutic device for men and women. Specifically, the device may be said to relate to functional jewelry. More specifically, the present invention relates to a rhythmic or vibrating device, such as a bracelet, for positively affecting physical, physiological, and/or psychological states in men and women.

### BACKGROUND OF THE INVENTION

Rhythmic beats have been known to induce different mind sets and physiological states in people since the dawn of time. Military and ritualistic drum beats are just a couple of examples where rhythm is used to induce a desired effect. Rhythms are just an everyday experience for many people, especially those who frequently listen to music. In fact, physiological rhythm pacemakers are now routinely used in medicine for patients.

What is new is that vibrational rhythms are the oldest in evolution and one of the most powerful, while also being one of the most subtle and least invasive. The effect of vibration stimulation can quickly and effectively change physiological conditions that otherwise might need years of training to overcome. Based on the physiological principle of entrainment, the inventors of the present application have developed a device that can provide that stimulation.

However, until the invention of the present application, the simple problem of getting rhythm to the general public went either unnoticed or unsolved by those skilled in many fields. The present invention provides an easy and inexpensive solution which will allow individuals to use and control rhythmic effects without interfering with work, rest or other people nearby.

### SUMMARY OF THE INVENTION

There is disclosed herein a wearable rhythmic device which avoids the disadvantages of prior devices while affording additional structural and operating advantages.

In an embodiment, a wearable rhythmic device for inducing different states of mind and physiological states in a wearer, is described. The device comprises a wearable band, a housing connected to the wearable band, and a rhythm and vibration mechanism contained within the housing.

In another embodiment, a method of for inducing a therapeutic state of mind and physiological states in a person, is described. The method includes the steps of providing a wearable article, connecting a housing to the wearable article, disposing a rhythm and vibration mechanism within the housing, and, activating the rhythm and vibration mechanism when the wearable article is worn.

These and other aspects of the device and method may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of an embodiment of the wearable rhythmic device of the present disclosure; and,

FIG. 2 is a schematic of the working components of the wearable rhythmic device.

### DETAILED DESCRIPTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

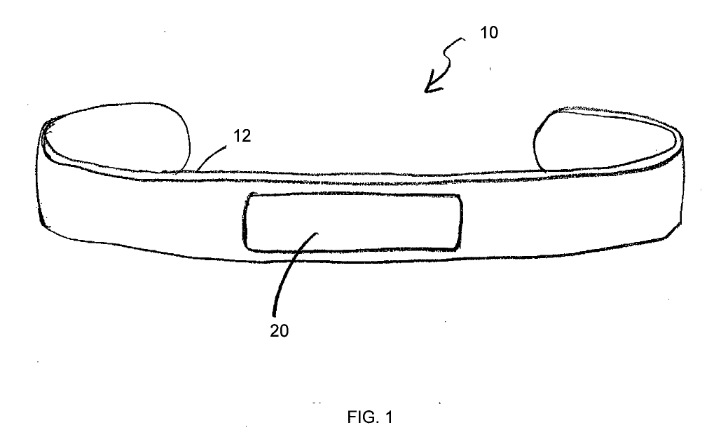

Referring to FIG. 1, there is illustrated a wearable rhythmic device 10 of the present disclosure. The particular embodiment illustrated is for a bracelet to be worn by a user in contact with the skin. In fact, while the embodiment described is directed to a wrist bracelet, it should be understood that the principles of the invention can be more broadly applied to ankle bracelets, necklaces, rings, or any other types of jewelry in contact with the wearer's skin.

As shown in FIG. 1, the wearable rhythmic device 10 is formed as a band 12 from any suitable material, including metal, rubber, silicone or leather. The bracelet band 12 may open as a simple semi-circular slip on, as shown, or may be in a continuous form, such as a bangle, or may include a clasp (not shown) for adjusting the size, so as to be wearable by a number of different people.

The bracelet band 12 also includes a housing 20 for containing the working mechanism 100 of the invention. The housing 20 may be formed in any shape, including circular, rectangular or square, and mounted or secured in any known manner to the bracelet band. For example, the housing 20 may be secured using small screws, or molded into the band 12 itself. In addition, although one housing 20 is shown, it should be understood that the present invention may include a number of housings for containing multiple vibration and rhythmic mechanism components 100. Also, the housing 20 may be positioned anywhere on the bracelet band 12.

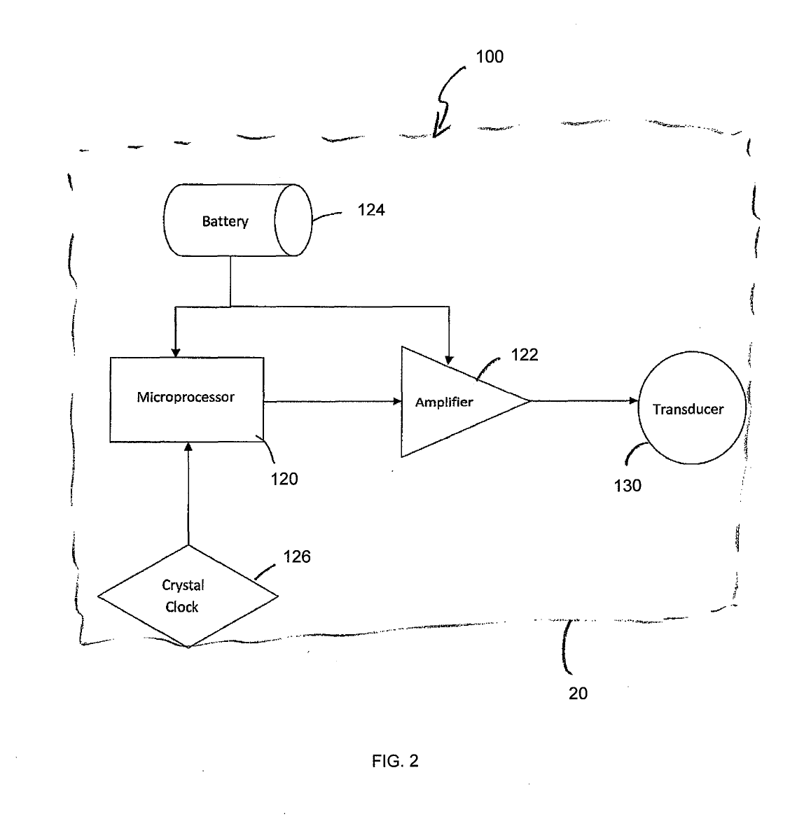

Referring to FIG. 2, there is illustrated a schematic of the vibration and rhythmic mechanism 100 of the wearable rhythmic device 10 of the present disclosure. The mechanism 100 comprises only a few key components. In one embodiment, a microprocessor 120 is electronically coupled to an amplifier 122 with both being powered by a suitable battery 124, such as a typical button-battery as is known in the art. It should be understood that the battery may also include a solar powered battery and/or a rechargeable battery. A crystal clock or crystal oscillator 126 is coupled to the microprocessor 120 to provide an electrical signal with a very precise frequency using a vibrating crystal of piezoelectric material. This frequency is commonly used to keep track of time (as in quartz wristwatches), to provide a stable clock signal for digital integrated circuits, and to stabilize frequencies for radio transmitters and receivers. The most common type of piezoelectric resonator used is the quartz crystal. These crystals are manufactured in abundance and can have a frequency from a few tens of kilohertz (KHz) to tens of megahertz (MHz).

A transducer 130 is connected to the amplifier 122 in the illustrated embodiment. The transducer 130 converts the electrical signal pulse to a mechanical or acoustic energy which can be felt or heard by the bracelet user.

The wearable rhythmic device 10 is designed to provide rhythmic and/or vibrational stimulation by the push of a button (not shown). The rhythm and/or vibration imparted to the user induces at least four states: active and energetic alertness, moderate strong and prolonged physical performance (marathoner style to be “in the zone”), super-performance, and although brief, sprinter's style quick deep relaxation.

During field trials of the testing device on athletes, the wearable rhythmic device 10 produced initial encouraging results. The present device 10 may have other applications for the general public, including possible medical uses relating to physiotherapy and relaxation.

The matter set forth in the foregoing description and accompanying drawings is offered by way of illustration only and not as a limitation. While a particular embodiment has been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A wearable rhythmic device for inducing different states of mind and physiological states in a wearer, the device comprising:
a wearable band;
a housing connected to the wearable band; and,
a rhythm and vibration mechanism contained within the housing.

2. The wearable rhythmic device of claim 1, wherein the rhythm and vibration mechanism further comprises:
microprocessor;
an amplifier coupled to the microprocessor;
a crystal oscillator electrically coupled to the microprocessor;
a power source; and,
a transducer.

3. The wearable rhythmic device of claim 2, wherein the power source is a battery.

4. The wearable rhythmic device of claim 1, further comprising an on-off switch.

5. The wearable rhythmic device of claim 2, wherein the oscillation frequency of the crystal oscillator is variable.

6. The wearable rhythmic device of claim 1, wherein the device is jewelry.

7. The wearable rhythmic device of claim 1, wherein the device is a bracelet.

8. A wearable rhythmic and vibrational bracelet for inducing different states of mind and physiological states in a wearer, the bracelet comprising:
a wearable band;
a housing connected to the wearable band; and,
a rhythm and vibration mechanism contained within the housing, the mechanism further comprising:
a microprocessor;
an amplifier coupled to the microprocessor;
a crystal oscillator electrically coupled to the microprocessor;
a power source; and,
a transducer.

9. A method for inducing a therapeutic state of mind and physiological states in a person, the method comprising the steps of:
providing a wearable article;
connecting a housing to the wearable article;
disposing a rhythm and vibration mechanism within the housing; and,
activating the rhythm and vibration mechanism when the wearable article is worn.

10. The method of claim 9, wherein the wearable article is a bracelet.

11. The method of claim 9, wherein in the step of activating the rhythm and vibration mechanism, the mechanism comprises:
a microprocessor;
an amplifier coupled to the microprocessor;
a crystal oscillator electrically coupled to the microprocessor;
a power source; and,
a transducer.

12. The method of claim 11, wherein the step of activating the rhythm and vibration mechanism further includes providing an electrical signal pulse from the crystal oscillator pulse to the transducer.

13. The method of claim 13, wherein transducer converts the electrical signal pulse to a mechanical or acoustic energy.

14. The method of claim 14, wherein the mechanical or acoustic energy induces a positive state of mind and positive physiological state in a wearer.
